(19) United States
(12) Patent Application Publication
(10) Pub. No.: US 2004/0189535 A1
(43) Pub. Date: Sep. 30, 2004

(54) Nx antenna for wireless communication

(76) Inventor: Young Joon Kim, Seoul (KR)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/477,182

(22) PCT Filed: May 13, 2002
(86) PCT No.: PCT/KR02/00885

(30) Foreign Application Priority Data
Oct. 31, 2001 (KR) 2001/0067318

(51) Int. Cl. H01Q 1/24

(52) U.S. Cl. 343/702; 343/900; 343/725

(57) ABSTRACT

The invention is an antenna for a wireless communication, comprising a cylindrical holder including a closed end and a side portion; and a rod including one end connected to the closed end of the holder.

### TECHNICAL FIELD

The present invention relates to an antenna for a wireless communication, and more particularly, to an nX antenna for a wireless communication terminal having a small size, a high power communication capability, good frequency and gain characteristics, and suitable for a wireless communication antenna. Further, this invention relates to an nX antenna for a wireless communication terminal, which is suitable for an armored and built-in antenna of a mobile communication terminal, etc.

### BACKGROUND ART

Through the present application, “nX antenna” is named from a type of an electrical charge flow depending on the structural characteristics of antennas disclosed by the present invention.

Due to rapid developments in the analog and digital communication technologies worldwide at the present, mobile communication services, such as cellular, PCS, GSM, PHS, Iridium service using an artificial satellite, IMT2000 service, etc., are being provided. Also, wireless communication is being used in various fields, such as wireless LAN, radios, wireless communication between apparatuses positioned within a local area, and wireless communication fields are being widely spread.

For instance, the mobile communication terminal antenna mainly uses the nondirectional retractable antenna owing to requirements in that bi-directional communications are possible and it is easy to carry the antenna. Antennas of terminals that are being sold are a combination type in which an antenna suitable for a signal standby state, and an antenna suitable for telephoning state are combined, and antennas capable of transmitting and receiving linear polarization signals easily are used.

The antenna type which is protruded upward from the terminal mainly employs a combination type in which a spring shaped helical antenna and a monopole shaped whip antenna which is extracted upward to enhance communication quality are combined. In other words, in the mobile terminals, such as mobile phones, radios, PCS, etc., for performing wireless communication between moving terminals, or between a moving terminal and a fixed place, the antennas are using a combination type of a whip antenna and a helical antenna.

FIG. 1 is a schematic view of a conventional helical-whip combination type antenna With reference to FIG. 1, the conventional helical-whip combination type antenna is described. The basic structure includes a helical antenna 2 and a whip antenna 3. The helical antenna 2 has a spiral conductor of which length is a deformation of approximately λ/4. The whip antenna has a monopole shape. In signal standby state or when surrounding environment is good, the helical antenna 2 along operates, and at a place where the electromagnetic wave environment is bad, the two antennas 2 and 3 operate at the same time in a state where the whip antenna 3 is extracted from a main body 1. The antennas are classified depending on positions of the helical antenna 2, and there are many modifications depending on the feeding ways and combination ways of the two antennas. Antennas for mobile communication terminals, having a structure in which the helical antenna 2 is coupled to one end of the whip antenna 3 are being used as representative antennas for foreign PCS terminal products and local products. A representative of these antennas is products made by Allgon company in Sweden, which is a company manufacturing antennas professionally. A structure, in which the helical antenna is coupled to the main body of the terminal, i.e., lower feeding points of the helical antenna and the whip antenna are connected to the same metal connector 4. American Motorola, Inc. manufactured an antenna having the same basic structure as the product of Allgon Company but different feeding method, and equipped the antenna in some terminal models, and is using the products. In early stage, Korean cellular terminal models mostly used products of Allgon Company.

However, since this conventional mobile communication antenna is made in a protruded structure from the terminal, the protruded antenna may be broken by an external force, or be fractured. Also, in case that a user moves with putting the terminal in one of pockets, the antenna is caught by a portion of the pocket, so that an inconvenience in putting and taking the terminal in the pocket is caused.

Also, since the antenna has a limitation in decreasing the size thereof due to the used frequency characteristic in the above structure, although the terminal size decreases, the antenna size does not decrease. Also, an area occupied by the antenna becomes larger. The antenna is being manufactured in a protruded structure alone.

Further, owing to the limitation in the performance of the antenna, the conventional antenna has the largest disadvantage in that communication quality, such as busy noise, cut off in calling, etc., is lowered.

FIGS. 2A and 2B are sectional views of improved antennas in accordance with a conventional art. In order to overcome the aforesaid disadvantages, a proposed conventional built-in antennas 10 and 20 for a mobile phone, as shown in FIGS. 2A and 2B, include first body parts 11 and 21, second body parts 12 and 22, spaces 13 and 23 and antenna rods 14 and 24. The first body parts 11 and 21 and the second body parts 12 and 22 are made of conductor, and have sealed upper faces and side faces, openings without a lower face. Diameters and lengths of the first body parts 11 and 21 and the second body parts 12 and 22 are decided depending on transmission and reception frequency band and their gains. The antenna rods 14 and 24 are made of conductor, and are inwardly coupled to the upper faces of the first body parts 11 and 21 and the second body parts 12 and 22 to be connected to each other and fixed. The spacers 13 and 24 are made of nonconductor, and are coupled to the openings of the first body parts 11 and 21 and the second body parts 12 and 22 to maintain intervals between the first body part 11 and the second body part 12 and between the first body part 21 and the second body part 22. The antennas can be set by finely controlling the intervals between the first body part 11 and the second body part 12 and between the first body part 21 and the second body part 22, where the spacers 13 and 23 are positioned.

Here, the conventional dipole antenna includes an anode and a cathode. Generally, a ground of the substrate itself or a cathode pattern formed on the substrate is used as the cathode, and an antenna structure itself is used as the anode. In describing the present invention, the anode is named antenna, and descriptions of the matching circuit and other circuits are omitted.

The antennas 10 and 20 are installed at the outside of the substrate. An antenna connector is electrically connected to an antenna circuit part on the substrate, and is installed on the substrate. In the dipole antenna, the antennas 10 and 20 are used as the anode, and a circuit substrate is used as the cathode. Instead of the circuit substrate, a cathode separately formed on the substrate can be used. This antenna is made such that it is equipped within the case of the mobile phone. As the cathode corresponding to the anode that is the antennas 10 and 20, a conductive pattern is used or an antenna structure having the same structure as the anode can be used.

Thus, in the antenna structure including the first body part 11 and 21, the second body parts 12 and 22, the spacers 13 and 23 and the antenna rods 14 and 24, phase inversion is repeated by an electric flow pattern of the surface and thus resonance is generated, so that a desired gain and frequency characteristic can be obtained by using an antenna having a short length in a structure on appearance.

Theses antennas can be installed at any position out of left side, right side, upper side and lower side. The cathode can be formed in a conductive pattern on the substrate to be matched with the anode. Two antennas having the same structure can be installed and connected respectively to the cathode and the anode. The two antennas can be installed in parallel to each other, or installed separately from each other in vertical direction and horizontal direction.

Then, in the foregoing antenna structure, when the two body parts are coupled such that their grooves face with each other, if the spacer of nonconductor is formed as an interval maintaining hole and the antenna rod is coupled to both end of the body parts using a screw or a stepped portion, the number of the elements becomes large, and since the antenna rod should be made longer to be coupled to the inside of the groove, the volume of the structure becomes large, so that there occur problems in that use of raw material increases, orientation toward light characteristic in weight is violated, assembly time increases, workability is lowered, and manufacturing costs are wasted.

Also, in the antenna structure, since the antenna is installed in a state in which the both ends are closed, there exists a drawback in which application width is limited in a structure connecting and installing the antenna to the circuit part of the substrate.

### DETAILED DESCRIPTION OF THE INVENTION

Accordingly, it is a first object of the present invention to enhance a communication quality by making an antenna for a mobile communication small in size and light in weight, and enhancing a receiving sensitivity.

It is a second object of the invention to lengthen a surface length of an antenna into which electric current flows while to shorten an appearance length of the antenna.

To accomplish the above objects, according to a first aspect of the invention, an antenna for a wireless communication, comprises: a holder part of a cylinder shape of which one end and side portion are closed; and a main rod part of which one end is connected to the closed one end of the holder part. The antenna may further comprise one or more auxiliary rod part connected in series to the main rod part. The main rod part has any one shape among a stick shape, a coil shape, a flat plate, and a board shape bent in a zigzag. The auxiliary rod part has one or more shape selected from a group consisting of a stick shape, a coil shape, a flat plate shape, and a board shape bent in a zigzag, and if the auxiliary rod part has two or more shapes selected from the group, the selected two are connected to each other in series. The antenna further comprises connection terminals for extracting different signals of a predetermined frequency band, the connection terminals being formed at a position where the rod part are connected with each other. The holder part, the main rod part, and the auxiliary rod part are plate-treated. The main rod part may be coupled to an inner portion or an outer portion of the closed one end of the holder part. If the main rod part is coupled to the inner portion of the closed one end of the holder part, it is apart from an inner wall of the side portion of the holder part, and the main rod part is longer than the holder part. The holder part may be a cylinder type, a polygonal cylinder type, or a wrinkle tube type. Also, the holder part is a hemisphere type or a cap type of which inside is vacant. The holder part, the main rod part, and the auxiliary rod part are plate-treated. The holder part and the main rod part are separately manufactured, the holder part has a hole formed at the closed one end, the main rod part has a stepped portion formed at one end thereof and the main rod part is inserted into the hole of the holder part to assemble the antenna.

To accomplish the above objects, according to a second aspect of the invention, a multi-stage antenna for a wireless communication, comprises: a holder part of a cylinder shape of which one end and side portion are closed; and a main rod part of which one end is connected to the closed one end of the holder part, wherein the antennas are connected with each other in series such that the other end of the main rod part in one of the antennas is coupled to the closed one end of the main rod part in another one adjacent to the one of the antennas. The multi-stage antenna further comprises one or more auxiliary rod part connected in series to the main rod part of the final stage antenna.

To accomplish the above objects, according to a third aspect of the invention, a two stages antenna for a wireless communication, comprises: a first holder part of a cylinder shape of which one end and side portion are closed; a second holder part of the cylinder shape of which one end and side portion are closed; a first main rod part of which one end is connected to the closed one end of the first holder part, so that the first main rod part is electrically connected with the first holder part; a second main rod part of which one end is connected to the closed one end of the second holder part, so that the second main rod part is electrically connected with the second holder part; and one or more auxiliary rod part connected in series between the first main rod part and the second main rod part.

To accomplish the above objects, according to a fourth aspect of the invention, a composite antenna for a wireless communication, comprises: a main wireless communication antenna manufactured according to the first aspect of the invention; one or more auxiliary wireless communication antenna manufactured according to the first aspect of the invention; and a flat plate-shaped connection rod part of which one face is connected in series to the man rod part of the main wireless communication antenna and the other face has a short stick for connection, the short stick being connected to the other face of the connection rod part, wherein the main rod parts of the respective auxiliary wireless communication antennas are connected in series to the one face of the connection rod part, and are connected to the connection rod part in parallel with the main wireless communication antenna The auxiliary wireless communication antennas are connected to the connection rod part. The composite antenna further comprises an auxiliary rod part connected in series to one end of the short stick of the connection rod part. The auxiliary rod parts are connected in series with each other, and connection terminals for extracting different signals of a predetermined frequency band are formed at a position where the auxiliary rod parts are connected with each other.

In the composite wireless communication antenna, the main wireless communication antenna and the auxiliary wireless communication antennas are coupled and manufactured in a package type, the connection rod part and the auxiliary rod parts are respectively and separately manufactured in a package shape, and the main wireless communication antenna, the auxiliary wireless communication antennas, the connection rod parts and the auxiliary rod parts are fitted in a connector of a corresponding socket and are assembled.

The holder part of the invention has a structure capable of lengthening a surface length through which electric current flows while decreasing an appearance length of the antenna. In order to lengthen the surface length, the holder part can be made in a wrinkle shape. Thus, in the wireless communication antenna in accordance with the invention, a conductive length is lengthened, a frequency resonance is generated and an antenna characteristic is enhanced while electric flow passes through the rod part, the inside of the groove of the holder part and the outer surface of the holder part. As a result, the antenna can be made to have a small size and length on appearance. Also, the frequency resonance characteristic is enhanced, so that a high power characteristic is obtained. Further, in the antenna of the invention, phase inversions of electromagnetic wave are performed differently depending on the connection position of the holder part, the rod part, and the multi-stage rod part. Around a center portion of cross points of the phases, since the inverted phase forms the alphabet letter “X”, the number of times (n) of the letter “X” increases by constituting the rod part in a multi-stage or in a multi-stage wireless communication antenna. Accordingly, in the present invention, an electrical flow having an nX pattern can be generated, and thus the antenna is named “nX antenna”.

The present invention is characterized in that connection means for connecting the antenna including the holder part and the rod part with an antenna circuit part of a substrate is provided by directly welling the end portion of the holder part, the rod part or the coil part to the substrate, or by a connector for inserting and thus connecting the end portion of the holder part, the rod part or the coil part to the substrate.

Also, the nX antenna of the invention can form the cathode using a conductive pattern formed on the substrate. The conductive pattern can have various shapes. Preferably, the conductive pattern is made in a shape having the same shape as the section of the nX antenna, thereby enhancing a frequency matching characteristic of the antenna serving as the anode, and the conductive pattern serving as the cathode.

Further, the nX antenna of the invention can be used in applications having various frequency bands, such as PCS, DCS, GPS, etc. This becomes possible by constituting the rod part in a multi-stage, designing a matching point for deciding the antenna length depending on the frequency characteristic at an arbitrary position, and connecting the connector. By connecting a matching circuit matched with a frequency band with each of the connectors and selecting the matching circuit, one antenna can be applied in various frequency bans.

### BRIEF DESCRIPTION OF THE DRAWINGS

FIG. 1 is a schematic view of a conventional helical-whip combination type antenna;

FIGS. 2A and 2B are sectional views of improved antennas in accordance with a conventional art;

FIG. 3A is a perspective view of an nX antenna in accordance with a first embodiment of the present invention;

FIG. 3B is a sectional view of the nX antenna in accordance with the first embodiment of the present invention;

FIG. 3C is a sectional view of an nX antenna in accordance with a second embodiment of the present invention;

FIG. 3D is a sectional view of an nX antenna in accordance with a third embodiment of the present invention;

FIG. 3E is a perspective view of an nX antenna in accordance with a fourth embodiment of the present invention;

FIG. 3F is a sectional view of an nX antenna in accordance with a fifth embodiment of the present invention;

FIG. 3G is a sectional view of an nX antenna in accordance with a sixth embodiment of the present invention;

FIG. 3H is a sectional view of an nX antenna in accordance with a seventh embodiment of the present invention;

FIG. 3I is a perspective view of an nX antenna in accordance with an eighth embodiment of the present invention;

FIG. 3J is a perspective view of an nX antenna in accordance with a ninth embodiment of the present invention;

FIG. 3K is a perspective view of an nX antenna in accordance with a tenth embodiment of the present invention;

FIG. 3L is a perspective view of an nX antenna in accordance with an eleventh embodiment of the present invention;

FIG. 4A is a perspective view of an nX antenna in accordance with a twelfth embodiment of the present invention;

FIG. 4B is a sectional view of the nX antenna in accordance with the twelfth embodiment of the present invention;

FIG. 5 is an exemplary view showing an application of the nX antenna in accordance with the present invention;

FIG. 6 is a disassembled perspective view of a coil type auxiliary rod part package in accordance with the present invention; and

FIG. 7 is a perspective view of an nX antenna in accordance with a thirteenth embodiment of the present invention.

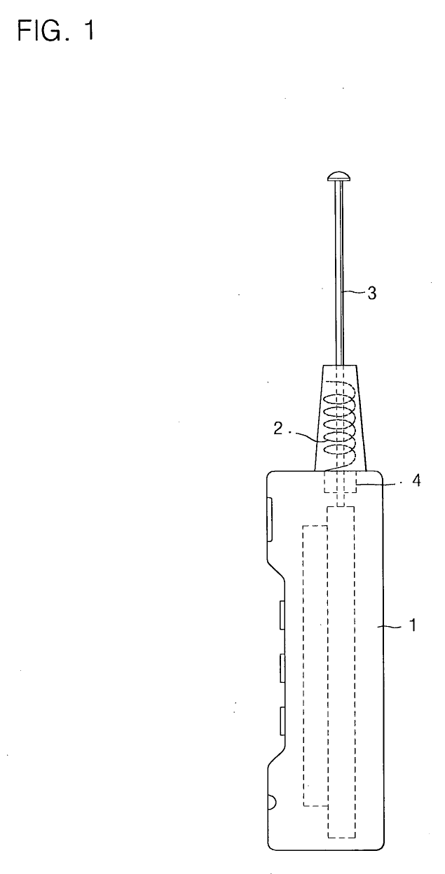

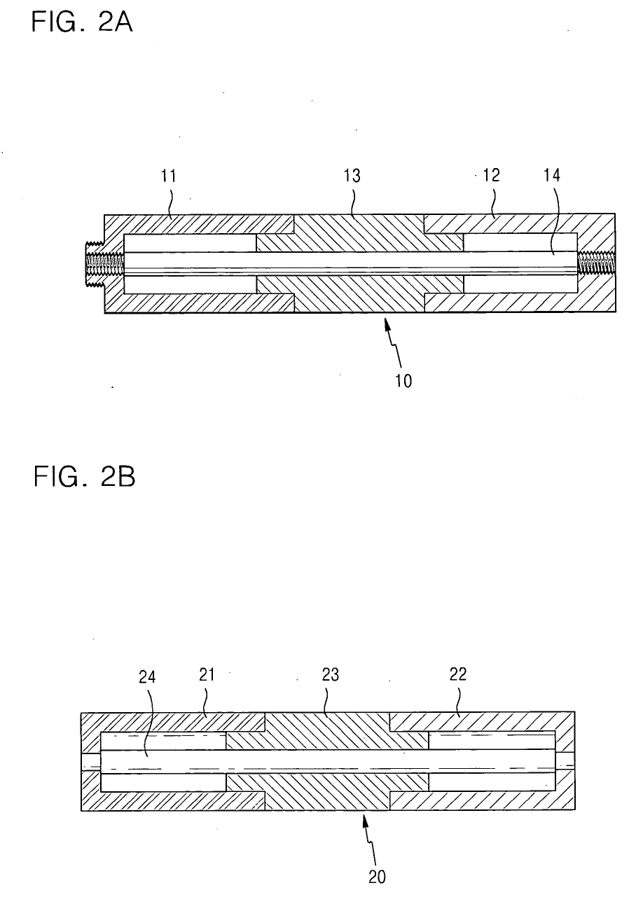

### DESCRIPTION OF REFERENCE NUMERALS IN MAIN PARTS OF THE DRAWINGS

1: Body part of telephone 2: Helical antenna

3: Whip antenna 4: Metal connector

10, 20: Conventional antenna 11, 21: 1^{st} body part

12, 22: 2^{nd} body part 13, 23: Spacer

14, 24: Rod

111, 121, 131, 141,151, 153, 161, 163, 171, 173, 181, 191, 211, 231, 251, 261, 281: Holder part

112, 122, 132, 142, 152, 154, 162, 164, 172, 174, 182, 192, 212, 232, 252, 282:

Stick type rod part

123, 165, 175, 183, 194, 262, 264: Coil type rod part

133: Zigzag type rod part

143, 184, 193, 195, 213, 233, 253, 263: Plate type rod part

210, 230: Main antenna 220, 240: Auxiliary antenna

P1, P2, P3, 284: Matching point

265, 266, 267: Matching circuit

268: Selection circuit 271: Case

272: Insulator resin 273: Coil

274: Elastic connector 285: Substrate

283: Auxiliary rod part formed as circuit pattern

### DETAILED DESCRIPTION OF THE PREFERRED EMBODIMENT

Hereinafter, preferred embodiments of the present invention are described in detail with reference to the accompanying drawings.

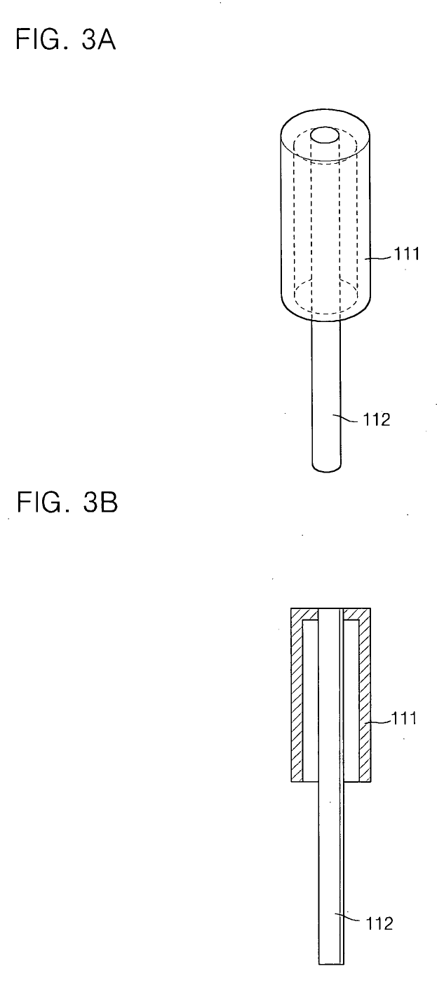

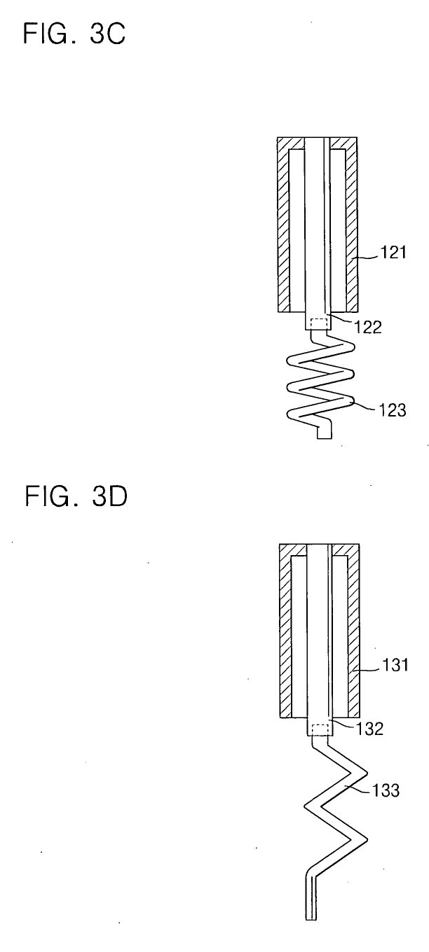

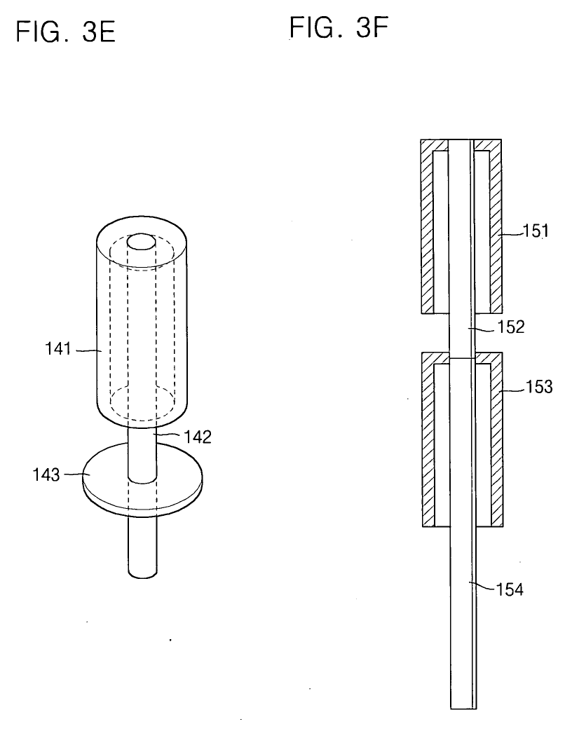

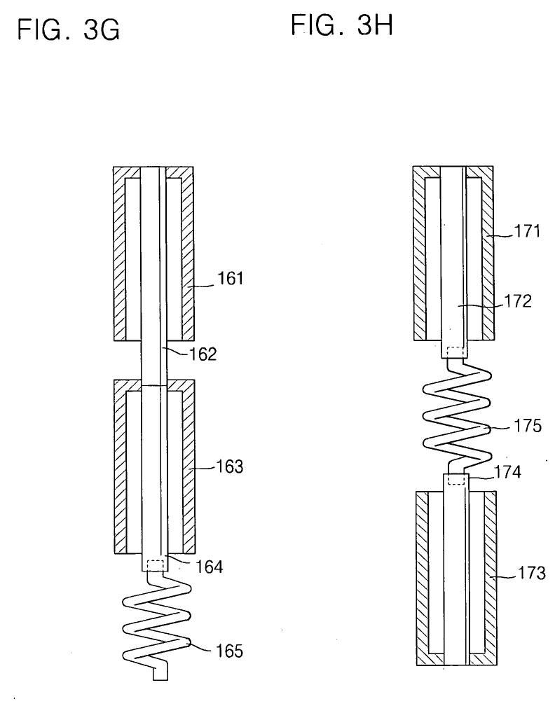

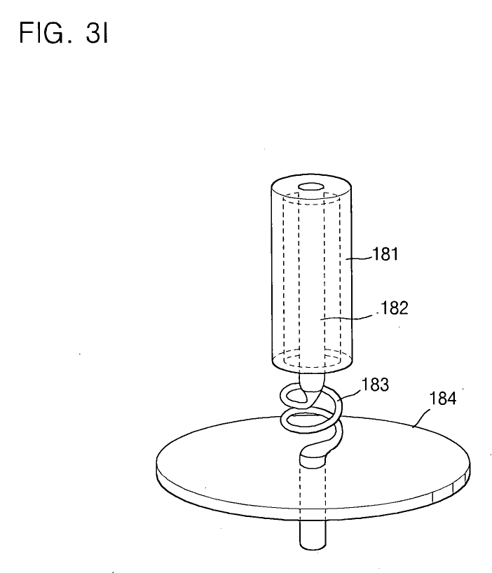

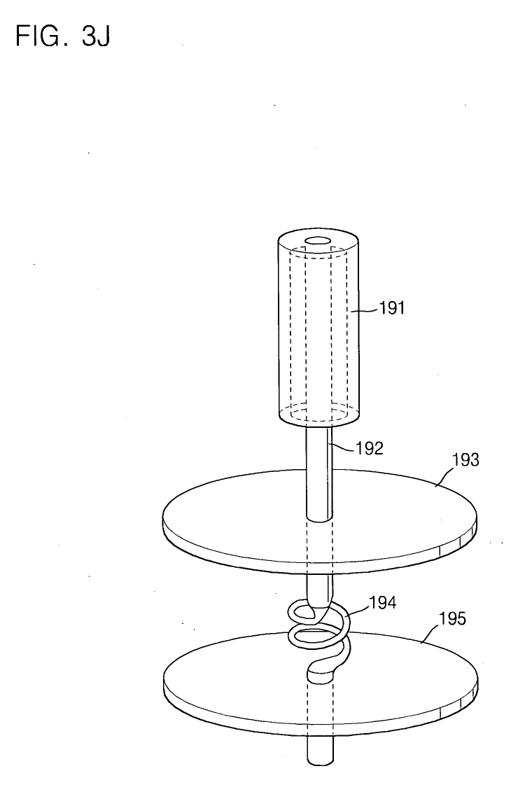

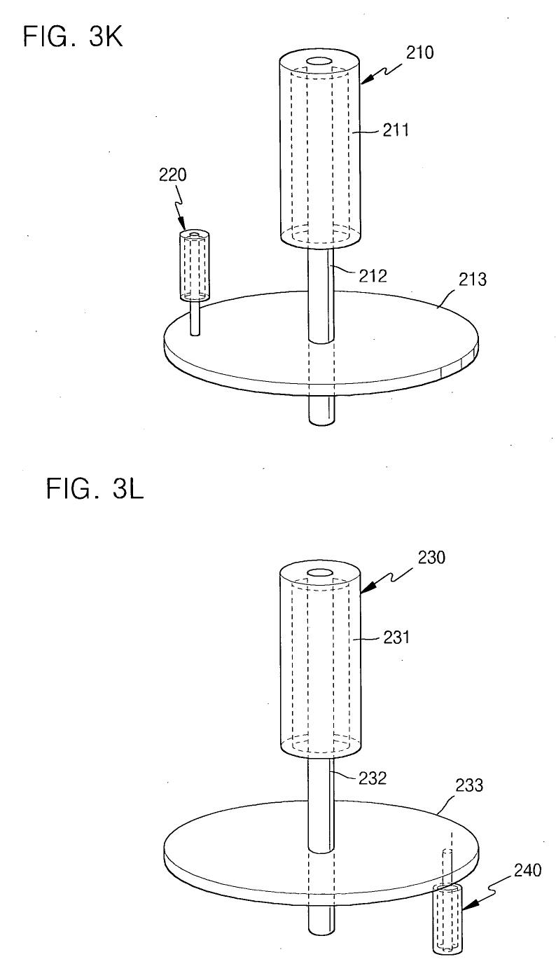

FIG. 3A is a perspective view of an nX antenna in accordance with a first embodiment of the present invention, and FIG. 3B is a sectional view of the nX antenna in accordance with the first embodiment of the present invention With reference to FIGS. 3A and 3B, the first embodiment is described in detail.

A stick type rod 112 is connected to one end (upper side) of a holder part 111. The stick type rod part 112 is apart from the side inner wall of the holder part. The stick type rod part 112 is longer than the holder part 111. So, the stick type rod part 112 has an appearance to extend outside the holder part by a predetermined length. Thus, the stick type rod part 112 is positioned within the holder part 111, thereby enhancing inner and outer resonance effects of electromagnetic waves, and allowing an overall length of the antenna to be shortened. Further, a connection terminal is formed in the stick type rod part 112 to thereby connect an electromagnetic wave having a necessary wavelength to a circuit.

FIG. 3C is a sectional view of an nX antenna in accordance with a second embodiment of the present invention. With reference to FIG. 3C, the second embodiment is described in detail.

The antenna of the second embodiment including a holder part 121 and a stick type rod part 122 basically has the same structure as that of the first embodiment. In addition, the antenna of the second embodiment has a coil type rod part 123 connected to the stick type rod part 122. This composite type antenna has a structure in which the holder part 121, the stick type rod part 122 and the coil type rod part 123 are connected. Why the coil type rod part 123 is connected to the stick type rod part 122 is to lengthen an overall length of the antenna while to maintain a real length of the antenna, in case where it is requested to lengthen the antenna due to the frequency characteristic, i.e., when the antenna is used in a low frequency band. Further, one or more connection terminal may be formed in the stick type rod part 122 and the coil type rod part 123 to connect an electromagnetic wave having a necessary wavelength to a circuit. Furthermore, one or more arbitrary rod part, such as a stick type rod part, a coil type rod part, a plate type rod part, a zigzag type rod part, etc., is connected to the coil type rod part 123, and one or more connection terminal is connected to the arbitrary rod part, thereby connecting an electromagnetic wave having a necessary wavelength to a circuit.

FIG. 3D is a sectional view of an nX antenna in accordance with a third embodiment of the present invention. With reference to FIG. 3, the third embodiment is described in detail.

In the antenna of the third embodiment, a zigzag type rod part 133 having a shape in which a board is bent in a zigzag is further connected to a stick type rod part 132 of the basic structure shown in the first embodiment. The zigzag type rod part 133 has connection terminals at both ends thereof This composite type antenna has a shape in which a holder part 131, the stick type rod part 132 and the zigzag type rod part 133 are connected. Why the zigzag type rod part 133 is connected to the stick type rod part 132 is to lengthen an overall length of the antenna while to maintain a real length of the antenna, in case where it is requested to lengthen the antenna due to the frequency characteristic, i.e., when the antenna is used in a low frequency band. The zigzag type rod part 133 of the third embodiment has the same function as the coil type rod part 123 of the second embodiment. Further, one or more connection terminal may be formed in the stick type rod part 132 and the zigzag type rod part 133 to connect an electromagnetic wave having a necessary wavelength to a circuit. Furthermore, one or more arbitrary rod part, such as a stick type rod part, a coil type rod part, a plate type rod part, a zigzag type rod part, etc., is connected to the zigzag type rod part 133, and one or more connection terminal is connected to the arbitrary rod part, thereby capable of connecting an electromagnetic wave having a necessary wavelength to a circuit.

FIG. 3E is a perspective view of an nX antenna in accordance with a fourth embodiment of the present invention. With reference to FIG. 3E, the fourth embodiment of the invention is described in detail.

In the antenna of the fourth embodiment, a plate type rod part 143 is further connected to a stick type rod part 142 of the basic structure shown in the first embodiment. This composite type antenna has a shape in which a holder part 141, the stick type rod part 142 and the plate type rod part 143 are connected. Why the plate type rod part 143 is connected to the stick type rod part 142 is to lengthen an overall length of the antenna while to maintain a real length of the antenna, in case where it is requested to lengthen the antenna due to the frequency characteristic, i.e., when the antenna is used in a low frequency band. The plate type rod part 143 of the fourth embodiment has the same function as the coil type rod part 123 of the second embodiment and the zigzag type rod part 133 of the third embodiment. Further, one or more connection terminal may be formed in the stick type rod part 142 and the plate type rod part 143 to connect an electromagnetic wave having a necessary wavelength to a circuit. Furthermore, one or more arbitrary rod part, such as a stick type rod part, a coil type rod part, a plate type rod part, a zigzag type rod part, etc., is connected to the plate type rod part 143, and one or more connection terminal is connected to the arbitrary rod part, thereby capable of connecting an electromagnetic wave having a necessary wavelength to a circuit.

FIG. 3F is a sectional view of an nX antenna in accordance with a fifth embodiment of the present invention. With reference to FIG. 3E, the fourth embodiment of the invention is described in detail.

In case where it is requested that the antenna length be lengthened in the basic structures shown in FIGS. 3A and 3B according to a characteristic of a corresponding antenna-used frequency, a first antenna having the same basic structure than that of the first embodiment, i.e., having a first holder part 151 and a first stick type rod part 152, and a second antenna having the same basic structure, i.e., having a second holder part 153 and a second stick type rod part 154, are connected with each other, in which one end of the first stick type rod part 152 is connected to an outer face of an upper side of the second holder part 153, thereby constituting the antenna in a two stage. By using this coupling way, it is also possible to constitute the antenna in a multi-stage. Further, one or more connection terminal may be formed in the first stick type rod part 152 and the second stick type rod part 154, thereby capable of connecting an electromagnetic wave having a necessary wavelength to a circuit. Furthermore, one or more arbitrary rod part, such as a stick type rod part, a coil type rod part, a plate type rod part, a zigzag type rod part, etc., is connected to the second stick type rod part 154, and one or more connection terminal is connected to the arbitrary rod part, thereby capable of connecting an electromagnetic wave having a necessary wavelength to a circuit.

FIG. 3G is a sectional view of an nX antenna in accordance with a sixth embodiment of the present invention. With reference to FIG. 3G, the sixth embodiment of the invention is described in detail.

The antenna of the sixth embodiment has structure in which the second embodiment and the fifth embodiment are coupled. In the same structure than the fifth embodiment, including a first holder part 161, a second holder part 163, a first stick type rod part 162 and a second stick type rod part 164, a coil type rod part 165 is further connected to the second stick type rod part 164. In other words, the coil type rod part 165 is further added to the multi-structure, thereby capable of constituting a multi composite structure. Why the coil type rod part 165 is connected to the stick type rod part 164 is to lengthen an overall length of the antenna while to maintain a real length of the antenna, in case where it is requested to lengthen the antenna due to the frequency characteristic, i.e., when the antenna is used in a low frequency band. Further, one or more connection terminal may be formed in the first stick type rod part 162, the second stick type rod part 164 and the coil type rod part 165, thereby capable of connecting an electromagnetic wave having a necessary wavelength to a circuit. Furthermore, one or more arbitrary rod part, such as a stick type rod part, a coil type rod part, a plate type rod part, a zigzag type rod part, etc., is connected to the coil type rod part 165, and one or more connection terminal is connected to the arbitrary rod part, thereby capable of connecting an electromagnetic wave having a necessary wavelength to a circuit.

As a modified example of the sixth embodiment, an antenna in which the fifth embodiment and the third embodiment are coupled, or an antenna in which the fourth embodiment and the third embodiment are coupled, can be made like the above description

FIG. 3H is a sectional view of an nX antenna in accordance with a seventh embodiment of the present invention. With reference to FIG. 3H, the seventh embodiment of the invention is described in detail.

The antenna of the seventh embodiment is made by allowing a stick type rod part 172 of a first antenna including a holder part 171 and the stick type rod part 172 and having the same structure than the first embodiment, and a stick type rod part 174 of a second antenna including a holder part 173 and the stick type rod part 174 and having the same structure than the first embodiment to face with each other, and by connecting a coil type rod part 175 between the facing stick type rod parts 172 and 174. At this time, instead of the coil type rod part 175, a plate type rod part having a predetermined diameter, any one out of a long stick type rod part and a zigzag type rod part in which a board is bent in a zigzag is used, thereby capable of constituting an antenna to perform the function of the coil type rod part 175. Further, one or more connection terminal may be formed in the stick type rod parts 172 and 174, and the coil type rod part 175, thereby capable of connecting an electromagnetic wave having a necessary wavelength to a circuit. Furthermore, one or more rod part, such as a stick type rod part, a coil type rod part, a plate type rod part, a zigzag type rod part in which a board is bent in a zigzag, etc., is connected in series, and the serially connected rod parts can be used instead of the coil type rod part 175. Of course, one or more connection terminal is connected to the rod parts, thereby capable of connecting an electromagnetic wave having a necessary wavelength to a circuit.

FIG. 3I is a perspective view of an nX antenna in accordance with an eighth embodiment of the present invention. With reference to FIG. 3I, the eighth embodiment of the invention is described in detail.

In the same structure than the second embodiment, including a holder part 181 and a coil type rod part 183, a plate type rod part 184 is further connected to the coil type rod part 183. This composite structure antenna has a structure in which the holder part 181, a stick type rod part 182 and the coil type rod part 183 are connected. Why the coil type rod part 183 is connected to the stick type rod part 182 and the plate type rod part 184 is connected to the coil type rod part 183 is to lengthen an overall length of the antenna while to maintain a real length of the antenna, in case where it is requested to lengthen the antenna due to the frequency characteristic, i.e., when the antenna is used in a low frequency band. Further, one or more connection terminal may be formed in the stick type rod part 182, the coil type rod part 183 and the plate type rod part 184 to connect an electromagnetic wave having a necessary wavelength to a circuit. Furthermore, one or more arbitrary rod part, such as a stick type rod part, a coil type rod part, a plate type rod part, a zigzag type rod part, etc., is connected to the plate type rod part 183, and one or more connection terminal is connected to the arbitrary rod part, thereby capable of connecting an electromagnetic wave having a necessary wavelength to a circuit.

FIG. 3J is a perspective view of an nX antenna in accordance with a ninth embodiment of the present invention. With reference to FIG. 3J, the ninth embodiment of the invention is described in detail.

The present ninth embodiment may be referred to as a modified example of the fourth embodiment. In. the same structure than the second embodiment, including a holder part 191 and a plate type rod part 193, a coil type rod part 194 is further connected to the plate type rod part 193, and another plate type rod part 195 is also connected to the coil type rod part 194. This composite structure antenna has a structure in which the holder part 191, a stick type rod part 192, the plate type rod part 193, the coil type rod part 194 and the plate type rod part 195 are connected. Why the plate type rod part 193 is connected to the stick type rod part 192, the coil type rod part 194 is connected to the plate type rod part 193 and the plate type rod part 195 is connected to the coil type rod part 194 is to lengthen an overall length of the antenna while to maintain a real length of the antenna, in case where it is requested to lengthen the antenna due to the frequency characteristic, i.e., when the antenna is used in a low frequency band. Further, one or more connection terminal may be formed in the stick type rod part 192, the plate type rod part 193, the coil type rod part 194 and the plate type rod part 195 to connect an electromagnetic wave having a necessary wavelength to a circuit. Furthermore, one or more arbitrary rod part, such as a stick type rod part, a coil type rod part, a plate type rod part, a zigzag type rod part, etc., is connected to the plate type rod part 195, and one or more connection terminal is connected to the arbitrary rod part, thereby capable of connecting an electromagnetic wave having a necessary wavelength to a circuit.

The ninth embodiment has the structure in which the plate type rod parts 193 and 195 are constituted in a two-stage and the coil type rod part 194 is added between the plate type rod parts 193 and 195. Instead of the coil type rod part 194, one or more arbitrary rod part, such as a stick type rod part, a coil type rod part, a plate type rod part a zigzag type rod part, etc., is used, thereby capable of constituting the antenna. Of course, the plate type rod part can be also constituted in the two-stage or a multi-stage, and the coil type rod part can be inserted one or more.

FIG. 3K is a perspective view of an nX antenna in accordance with a tenth embodiment of the present invention. With reference to FIG. 3K, the tenth embodiment of the invention is described in detail.

The present tenth embodiment corresponds to a structure in which the first embodiment and the fourth embodiment are coupled. An antenna 210 having the same structure as the fourth embodiment, including a holder part 211, a stick type rod part 212 and a plate type rod part 213, is used as the main antenna 210. And, an antenna 220 having the same structure as the first embodiment is used as the auxiliary antenna 220. In this embodiment, a stick type rod part of the auxiliary antenna 220 is connected to an upper face of the plate type rod part 213 of the main antenna 210. Also, the size of the plate type rod part 213 are designed differently depending on frequency characteristic and use thereof, and are designed considering the main antenna and the auxiliary antenna. In case of using the plate type rod part 213, the antenna is suitable for a high power, can be utilized as antennas for a fixed station or a base station, and even can be applied to terminals.

The auxiliary antenna can be connected one or more. And, in the aforementioned embodiments or modified examples, if the antennas have the plate type rod part, they can be used as the main antenna. In particularly, the antennas described in the fourth, eighth and ninth embodiments are appropriate for the main antenna. Also, in the aforementioned embodiments and the modified examples, arbitrary one may be used as the auxiliary antenna.

FIG. 3L is a perspective view of an nX antenna in accordance with an eleventh. embodiment of the present invention With reference to FIG. 11, the eleventh embodiment is described in detail.

The present eleventh embodiment corresponds to a structure coupled differently from the tenth embodiment in which the first embodiment and the fourth embodiment are coupled. An antenna 230 having the same structure as the fourth embodiment, including a holder part 231, a stick type rod part 232 and a plate type rod part 233 is used as the main antenna 230. And, an antenna 240 having the same structure as the first embodiment is used as the auxiliary antenna 240. A stick type rod part of the auxiliary antenna 240 is connected to a lower face of the plate type rod part 233 of the main antenna 230. The auxiliary antenna can be connected one or more. Also, the size of the plate type rod part 233 are designed differently depending on frequency characteristic and use thereof, and are designed considering the main antenna and the auxiliary antenna. In case of using the plate type rod part 233, the antenna is suitable for a high power, can be utilized as antennas for a fixed station or a base station, and even can be applied to terminals.

The auxiliary antenna can be connected one or more. And, in the aforementioned embodiments or modified examples, if the antennas have the plate type rod part, they can be used as the main antenna. In particularly, the antennas described in the fourth, eighth and ninth embodiments are appropriate for the main antenna. Also, in the aforementioned embodiments and the modified examples, arbitrary one may be used as the auxiliary antenna.

Further, by coupling the tenth embodiment and the eleventh embodiment, the stick type rod parts of the auxiliary antennas 220 and 240 may be connected to the upper face and the lower face of the plate type rod parts 213 and 233 of the main antennas 210 and 230. And, the auxiliary antenna can be connected one or more. Furthermore, in the aforementioned embodiments or modified examples, if the antennas have the plate type rod part, they can be used as the main antenna. In particularly, the antennas described in the fourth, eighth and ninth embodiments are appropriate for the main antenna. Also, in the aforementioned embodiments and the modified examples, arbitrary one may be used as the auxiliary antenna.

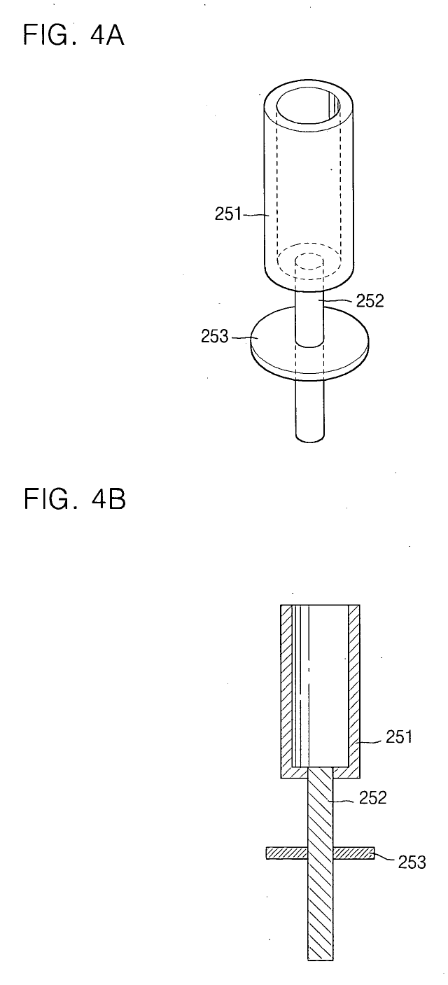

FIG. 4A is a perspective view of an nX antenna in accordance with a twelfth embodiment of the present invention, and FIG. 4B is a sectional view of the nX antenna in accordance with the twelfth embodiment of the present invention.

The present antenna has a structure in which a stick type rod part 252 is connected to an outer face of a closed one end of a holder part 251 in addition to the same structure as the fourth embodiment. In this structure, diameter and length are designed to generate resonance considering frequency used for wireless transmission and receipt and gain characteristic. A plate type rod part 253 is connected to the stick type rod part 252.

Further, by changing the connection portion between the closed one end and the rod part from the inner face of the closed one end of the holder part to the outer face of the closed one end in the structures of the first embodiment to the eleventh embodiment, and modified examples thereof, modified examples can be made. Furthermore, like the twelfth embodiment and the modified examples thereof, the connection portion between the closed one end of the holder part and the rod part may be changed into a mixed structure in which the connection portions are positioned at an outer face of the closed one end and an inner face of the closed one end.

In the aforementioned embodiments and modified examples thereof the holder part and the rod part connected to the holder part can be constituted in an integral type. Each of the rod parts is coupled to a predetermined portion of one end of another rod part, and the end of the rod part serves as a lead, to be directly soldered to a substrate or be coupled to the substrate using a separate connector. The holder part can be made in various shapes, such as a circular shape, a polygonal cylinder shape, a wrinkle tube shape, etc. Also, the holder part can be made in a hemisphere shape of which inside is vacant, or a cap shape. The plate type rod part may be constituted to have an arc shape wrinkle, which is to widen the surface area.

As exampled and described above, the antennas of the invention are not limited to the examples shown in the drawings. In other words, the rod part can be bent and inserted to be soldered as the lead, or be equipped in a connector. The holder part and the rod part can be installed parallel with a substrate so as to utilize a space. Also, installation position of the antenna can be changed. For instance, the antenna can be installed at a space formed by diagonally cutting a corner of the substrate, or at an arbitrary position.

Thus, in the nX antennas having the basic structure, frequency resonance is generated by the holder part and the rod part, and although not shown in the drawings, the nX antennas perform the functions as the antenna together with a cathode of a conductive pattern formed on the substrate. Thus, only by the holder part and the rod part, the antenna can obtain the resonance characteristic, so that the surface length of the antenna is more lengthened than the appearance length of the antenna and inner resonance s generated, thereby obtaining transmission and receipt performances of high power that is much enhanced than general communication antennas.

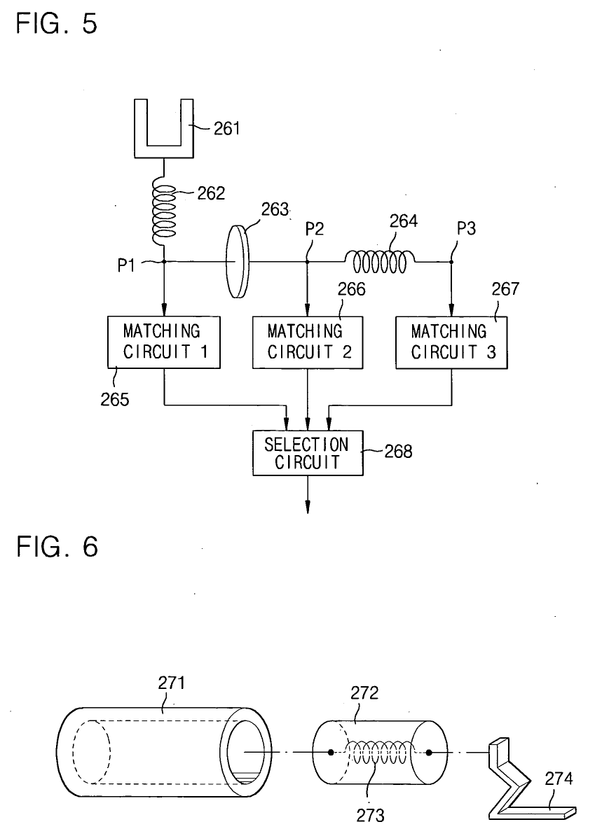

FIG. 5 is an exemplary view showing an application of the nX antenna in accordance with the present invention. With reference to FIG. 5, application examples of the nX antenna of the present invention can be described.

In case of communication means having different frequency bands, such as PCS, DCS, GPS, etc., antennas should be designed and made differently from each other. So, if a single antenna exists when designing an arbitrary wireless communication terminal, the antenna can be used in only a single frequency band. Considering this fact, the invention adds auxiliary rod parts 263 and 264 in order to extend a main rod part 262 connected to a holder part 261 of the antenna. For the auxiliary rod parts 263 and 264, the plate type rod part 263 and the coil type rod part are selected owing to the necessity thereof Matching points P1, P2 and P3 for deciding the length of the antenna depending on the frequency characteristic are designed at proper positions. Matching circuits 265, 266 and 267 suitable for respective frequency bands are connected to the respective matching points P1, P2 and P3, and a selection circuit for selecting the matching circuits 265, 266 and 267 are provided, so that one antenna can be applied to various frequency bands.

FIG. 6 is a disassembled perspective view of a coil type auxiliary rod part package in accordance with the present invention. With reference to FIG. 6, the coil type auxiliary rod part package structure of the nX antenna is described.

By packaging the coupling of the holder part and the main rod part or the auxiliary rod parts, the assembling or structure of the antenna is simplified. FIG. 6 is one example of the packaging, and shows the structure of the coil type auxiliary rod part package of the nX antenna. A coil 273 is molded by an insulator resin 272 and is then get into a case 271 to protect the coil 273. This packaged coil type auxiliary rod part is connected to a circuit by an elastic connector 274. Of course, the elastic connector 274 is made one pair such that it is connected to both sides of the packaged coil type auxiliary rod part and thus the coil type auxiliary rod part is fixed. In addition, various auxiliary rod parts can be packaged by the aforesaid way. Also, the holder part and the main rod part can be made in an integral structure by a method such as casting or the like. Furthermore, the holder part and the main rod part can be separately manufactured. At this time, a coupling hole is formed in the holder part and a coupling stepped portion is formed in the main rod part, and these two elements are coupled and assembled. The respective elements are plated to stabilize the performances of the antenna.

Also, the antenna needs means to connect it to the antenna circuit part, in which although not shown in the drawings, the rod part is directly soldered/welded to the substrate, or is connected to the antenna circuit part using a connector. One end of the holder part can be also connected using a welding or a connector. Further, the holder part is allowed to be insertion-fixed to the terminal case, and correspondingly a connector having elasticity is installed to fit the packaged rod part, thereby facilitating the antenna installation.

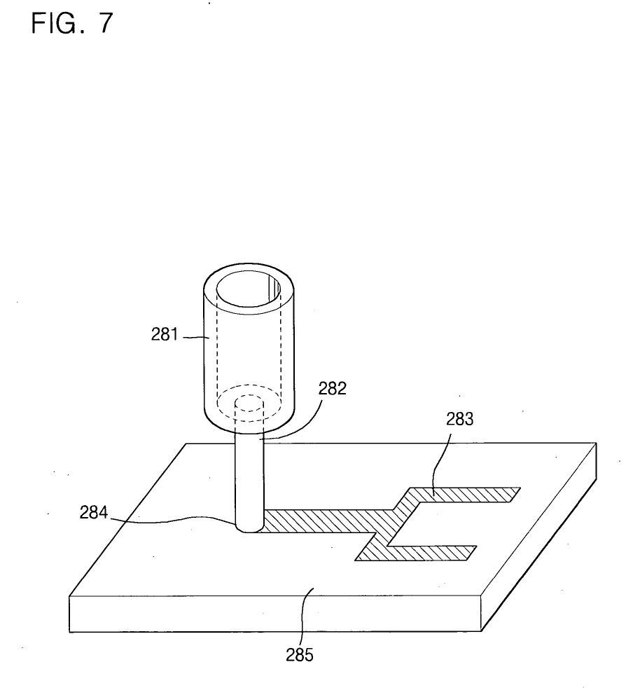

FIG. 7 is a perspective view of an nX antenna in accordance with a thirteenth embodiment of the present invention. With reference to FIG. 7, the thirteenth embodiment is described.

In a basic structure in which a stick type main rod part 282 is connected to an outer face of a closed one end of a holder part 281, an auxiliary rod part 283 formed in a circuit pattern on a substrate 285 is connected to the stick type main rod part 282. This circuit pattern, i.e., the auxiliary rod part 283 has the same shape as the longitudinal sectional view of the antenna in which the stick type rod part is connected to the outer face of the closed one end of the holder part. A matching point 284 is defined at a position where the stick type main rod part 282 and the auxiliary rod part 283 are connected, a connection terminal is formed at the matching point 284, and a matching circuit (not shown) is formed at the matching point 284.

Thus, the auxiliary rod part can be made in the form of pattern on the substrate. The pattern may be Y-letter shape, T-letter shape, or the same shape as the longitudinal sectional view of the antenna in which the stick type rod part is connected to the outer face of the closed one end of the holder part like the thirteenth embodiment. However, the third is most preferable.

The first embodiment to the twelfth embodiment, modified examples thereof, and combined examples thereof can be made like the thirteenth embodiment.

### Industrial Applicability

As described previously, the present invention is suitable for an antenna for a wireless communication having ultra-small in size and light in weight characteristics, and has an effect capable of providing an ultra-sized antenna having much enhanced performance compared with the conventional antenna. The present invention is suitable for a small-sized wireless communication apparatus, such as a mobile communication terminal, a wireless communication terminal for IMT2000, a wireless LAN communication terminal, etc., orienting toward small size and lightweight. In particular, it is suitable for an ultra-sized armored and built-in type antenna, and has an effect capable of applying it to a wireless communication between fixed stations, a wireless communication between a fixed station and a moving station, a wireless communication between moving stations, etc.

As described above, since the invention can constitute a basic antenna only by using a holder part of which inside is vacant, and a rod part, it is possible to provide an ultra-sized antenna, and to variously change the design thereof into a multi-stage structure, a composite structure to which a coil is added, a structure to which a flat plate is added, a structure in which main antenna part and auxiliary antenna part are compositely provided on the flat plate, etc., considering use object of the antenna, frequency characteristic and so on in order to utilize a low frequency band.

1-33 (Cancelled).

34. An antenna for a wireless communication, comprising:
a cylindrical holder including a closed end and a side portion; and
a rod including one end connected to the closed end of the holder.

35. The antenna as claimed in claim 34, wherein the rod is elongated.

36. The antenna as claimed in claim 34, comprising a coil connected to the rod.

37. The antenna as claimed in claim 34, comprising a flat plate having offset surfaces connected to the rod.

38. The antenna as claimed in claim 37, wherein the flat plate has an arc shape which is wrinkled.

39. The antenna as claimed in claim 34, wherein the rod is bent in a zigzag manner.

40. The antenna as claimed in claim 34, comprising another rod connected in series to the rod.

41. The antenna as claimed in claim 40, wherein the another rod has at least one shape selected from a group comprising an elongated rod, a coil, a flat plate, and a board bent in a zigzag manner.

42. The antenna as claimed in claim 40, wherein the another rod is a pattern formed on a substrate.

43. The antenna as claimed in claim 40, further comprising connection terminals for extracting different signals of a predetermined frequency band, the connection terminals being formed at a position where the rods are connected with each other.

44. The antenna as claimed in claim 40, wherein the holder, the rod, and the another rod are plated.

45. The antenna as claimed in claim 34, wherein the rod part is coupled to an inner portion of the closed end of the holder, and is spaced apart from an inner wall of the side portion of the holder.

46. The antenna as claimed in claim 34, wherein the rod is coupled to an outer face of the closed end of the holder.

47. The antenna as claimed in claim 34, wherein the holder is a cylinder.

48. The antenna as claimed in claim 34, wherein the holder is a polygonal shaped cylinder.

49. The antenna as claimed in claim 34, wherein the holder is a wrinkled tube.

50. The antenna as claimed in claim 34, wherein the holder is a hemisphere.

51. The antenna as claimed in claim 34, wherein the holder and the rod are separate parts, the holder has a hole formed at the closed end, the rod has a stepped portion formed at one end thereof, and the rod is inserted into the hole of the holder to assemble the antenna.

52. The antenna as claimed in clam 51, wherein the holder and the rod are separate parts, and the holder and the rod are inserted into connectors of a corresponding socket to assemble the antenna.

53. A multiple stage antenna for wireless communication each comprising:
a cylindrical holder with a closed end and a closed side portion; and
a rod with one end connected to the closed end of the holder; and wherein
the antennas are connected with each other in series so that an end of the rod part of one of the antennas is coupled to the closed one of the rod in another of the antennas.

54. The multiple stage antenna as claimed in claim 53, wherein the rods of the antennas include at least one shape selected from a group consisting of an elongated rod, a coil, a flat plate, and a board shape bent in a zigzag manner.

55. The multiple stage antenna as claimed in claim 53, comprising at least one additional rod connected in series to the rod of one of the antennas.

56. The multiple stage antenna as claimed in claim 53, wherein the rods are connected in series, and one of the rods has connection terminals for extracting different signals of a predetermined frequency band at a position where the rods are connected with each other.

57. The multiple stage antenna as claimed in claim 53, wherein one of the rods has at least one shape selected from a group consisting of an elongated rod, a coil, a flat plate, and a board shape bent in a zigzag manner.

58. A two stage antenna for a wireless communication, comprising:
a cylindrical first holder with a closed end and a closed side portion;
a cylindrical second holder with a closed end and a closed side portion;
a first rod with one end connected to the closed end of the first holder, so that the first rod is electrically connected with the first holder;
a second rod with one end connected to the closed end of the second holder, so that the second rod is electrically connected with the second holder; and
at least one additional rod is connected in series between the first rod and the second rod.

59. The antenna as claimed in claim 58, wherein the at least one additional rod has at least one selected from a group consisting of an elongated rod, a coil, a flat plate, and a board shape bent in a zigzag manner.

60. A composite antenna for a wireless communication, comprising:
a main wireless communication antenna including a cylindrical holder with a closed end and a closed side portion; and a rod with one end connected to the closed one end of the holder;
an auxiliary wireless communication antenna including a cylindrical holder with a closed end and a closed side portion; and a rod with one end connected to the closed end of the holder; and
a flat plate connection part with one face connected in series to the rod of the main wireless communication antenna and another face includes a connection rod for connection, the connection rod being connected to another face of the connection rod and wherein;
rods of the respective wireless communication antennas are connected in series to the one face of the connection rod, and are connected to the connection rod in parallel with the main wireless communication antenna.

61. The composite antenna as claimed in claim 60, wherein at least one of the wireless communication antennas is connected to the connection rod at a same face as a face to which the main wireless communication antenna is connected.

62. The composite antenna as claimed in claim 60, wherein at least one of the wireless communication antennas is connected to the connection rod at face opposite to a face to which the main wireless communication antenna is connected.

63. The composite antenna as claimed in claim 60, further comprising another rod connected in series to one end of the connection rod.

64. The composite antenna as claimed in claim 64, wherein the another rod of the connection are connected in series with each other, and connection terminals for extracting different signals of a predetermined frequency band are formed at a position where the auxiliary rod is connected with each other.

65. The composite antenna as claimed in claim 60, wherein the rod of the main wireless communication antenna is coupled to an outer face of the closed end of the holder.

66. The composite antenna as claimed in claim 60, wherein the rod of at least one auxiliary wireless communication antenna is connected to an outer face of the closed end of the holder thereof.
